(19) United States
(12) Patent Application Publication
(10) Pub. No.: US 2014/0303304 A1
(43) Pub. Date: Oct. 9, 2014

(54) Cationic Polymers And Methods Of Providing Antistatic Properties To Coating Materials

(71) Applicant: BASF SE, Ludwigshafen (DE)

(72) Inventors: Burkhard Frost, Seeg (DE); Fabien Brand, Huningue (FR)

(21) Appl. No.: 14/351,432

(22) PCT Filed: Oct. 19, 2012
(86) PCT No.: PCT/EP2012/004379

§ 371 Date: Apr. 11, 2014

Related U.S. Application Data
(60) Provisional application No. 61/548,774, filed on Oct. 19, 2011.

(30) Foreign Application Priority Data
Oct. 19, 2011 (EP) 11185840.3

(51) Int. Cl. C09D 5/24

(52) U.S. Cl. CPC C09D 5/24
USPC 524/426; 524/555; 524/548; 524/612; 524/519; 524/502; 524/516; 524/425

(57) ABSTRACT

Use of cationic polymers comprising quaternary nitrogen atoms as antistat in coating compositions, characterized in that the polymers are selected from the group consisting of compounds according to the formula (I), polydiallyldialkylamines and copolymers thereof, polyalkyleneimines, polyvinylimidazoles and copolymers thereof, and mixtures of these. The effect of the antistat is that dust adheres to a lesser degree to the coating of the composition. The compositions are employed more particularly in the interior architectural sector.

### CROSS-REFERENCE TO RELATED APPLICATIONS

This application is the National Stage entry of PCT/EP2012/004379, filed on Oct. 19, 2012, which claims priority to European Application Number 11185840.3, filed on Oct. 19, 2011, and U.S. Provisional Application No. 61/548,774, filed on Oct. 19, 2011, which are incorporated herein by reference in their entireties.

### FIELD OF THE INVENTION

The present invention relates to cationic polymers comprising quaternary nitrogen atoms as antistat in coating compositions, and methods of providing antistatic properties to coating materials.

### BACKGROUND OF THE INVENTION

Coating compositions for the interior architectural sector (interior coating compositions or interior coating materials) are subject to specific requirements. For example, these compositions must not have substances injurious to health on the surface or emit such substances from the coating into the ambient air. Moreover, they are to exhibit abrasion resistance and special surface qualities, and are to allow trouble-free renovation work. Furthermore, especially in wet rooms, the interior coating materials ought to be resistant to water and steam. In work rooms or children's rooms, resistance is required, for example, towards mechanical, physical and chemical burdens.

Exterior coating materials generally do not meet these requirements, since they emit health-injurious vapors even over a prolonged time, or have too low a hiding power (Kittel, Volume 6, S. Hirzel Verlag, Stuttgart, 2008, ISBN 978-3-776-1016-0, page 36).

A problem which frequently occurs in indoor rooms, however, is that dust settles on ceilings and walls especially above radiators, doors and windows. Nonuniform dust attraction is more conspicuous to an observer than a surface which exhibits homogeneous dust attraction. The settled dust (soiling) can frequently not be removed by washing or vacuuming. In general, time-consuming and costly renovation work is necessary.

Already disclosed in the prior art are coating materials which comprise antistats as additives for reducing the deposition of dust. The antistats are also referred to as dust preventatives (antidust agents, antidust additives).

Antistats prevent the electrostatic charging resulting from friction. The charging results in the attraction of particles of dust and dirt (Römpp Lexikon Chemie, 10th edition 1996, Volume 1, Georg Thieme Verlag Stuttgart and New York, ISBN 3-13-734610-X, entry heading Antistatika). In some cases the antistats are also referred to in the prior art as antidust additives.

JP 2009178954 A describes a cationic polyamine as antistatic polymer in a polyester film. The polyester film is used as a base film for transfer foils in transfer printing processes.

JP 2009019063 discloses ethylene/vinyl acetate copolymer compositions which are present in an antistatic resin layer. The coatings are applied to packing material.

DE 102006045869 describes methods for the antistatic treatment of coatings, paints or varnishes. Antistats used are ionic liquids such as 1,3-dialkylimidazolium.

DE 102007026551 discloses pigment preparations comprising at least one pigment and at least one compound of the general formula CH₃—(CH₂)ₙ—CH₂—O[(CH₂)ₚ—O]ₘ—H. The pigment preparation can be prepared by dispersing and drying. Its uses include antistatic treatment in water-based paint and varnish systems, emulsion paints, printing inks, liquid-ink systems and coating systems.

EP 1996657 A1 describes an antistatic coating composition which comprises a conductive polymer. Conductive polymers cited are polyanilines, polypyrroles and polythiophenes. The coating compositions are used as antistatic layer in antistatic polarization films on LCD display screens.

Also known are quaternary monoammonium compounds which are present as antistats in impregnating resin liquors (DE 102005029629 A1). The impregnating resin liquor is used for impregnating cellulosic fiber substances.

DE 2005013767 A1 describes aqueous preparations which exhibit dirt repellancy properties. They comprise polyurethanes, mineral particles and a polymer component which may comprise polyacrylates, polymethacrylates, polystyrene, polyvinyl acetate, polyurethanes, polyalkyds, polyepoxides, polysiloxanes, polyarylonitriles and/or polyesters. They are used for exterior coatings, more particularly for the coating of roof tiles.

Cationic polymers have the advantage that they migrate from the cured coating not at all or only in very small quantities, since in comparison to compounds of low molecular mass they have a reduced mobility. As a result of this, the antistatic effect is maintained for a longer time.

The prior art, however, has not disclosed any cationic polymers comprising quaternary nitrogen atoms that can be used as an antistat in interior coating materials in order to reduce dust soiling.

### BRIEF SUMMARY OF THE INVENTION

The problem addressed by the present invention, therefore, was that of eliminating the above-described disadvantages of the prior art. The intention was to provide cationic polymers comprising quaternary nitrogen atoms that can be used as antistats in coating compositions for the interior architectural sector (interior coating compositions). In contrast to the prior art, the coating resulting from application and drying ought to exhibit improved dust repellancy properties, thereby reducing dust deposition and soiling. At the same time, through the use of the cationic polymers, the coatings ought to exhibit no change in color and appearance, more particularly in terms of yellowing, relative to coatings of prior-art interior coating compositions which have reduced dust repellancy properties or none. Furthermore, the coatings ought to exhibit good abrasion resistance and have an antimicrobial effect. Moreover, the compositions ought to have shelf-life qualities, be amenable to processing, exhibit good flow, and have a low splash tendency.

The problem was directed more particularly to achieving a tradeoff between the antidust property, on the one hand, and the abrasion resistance and processing properties, on the other.

Principles and embodiments of the present invention relate to cationic polymers comprising quaternary nitrogen atoms, and providing antistatic properties to architectural coating materials that can be applied to interior and exterior surfaces. Surprisingly, cationic polymers comprising quaternary nitrogen atoms that can be used as antistats have been found which do not have the disadvantages of the prior art. More particularly, cationic polymers have been found that can be used in interior coating compositions. These compositions can produce resultant coatings combining very good dust repellancy properties with outstanding abrasion resistance and processing properties. In this way it has been possible to reduce dust deposition. At the same time it has not been possible to observe any alteration in the color or appearance of the coatings, more particularly in terms of yellowing. Furthermore, it has also been possible to achieve good shelf-life qualities on the part of the compositions. The coatings of the compositions, additionally, exhibited antimicrobial properties.

In addition, cationic polymers comprising quaternary nitrogen atoms can function as antistat in coating compositions, the polymers being selected from the group consisting of

a) compounds according to the formula (I),
b) polydiallyldialkylamines and copolymers thereof,
c) polyalkyleneimines,
d) polyvinylimidazoles and copolymers thereof, and
e) mixtures of these.

Principles and embodiments of the present invention relate to a method of providing antistatic properties to coating compositions comprising incorporating one or more cationic polymers comprising quaternary nitrogen atoms as an antistat to a coating composition, wherein the one or more cationic polymers are selected from the group consisting of compounds according to the formula (I),

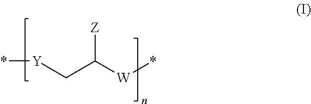

polydiallyldialkylamines and copolymers thereof, polyalkyleneimines, polyvinylimidazoles and copolymers thereof, and mixtures thereof, where in formula (I) n is an integer between 5 and 500; Z is H, C₁-C₁₈ alkyl, OH, C₁-C₁₈ alkoxy, a group C(O)R₁₀, —O—C(O)R₁₀ or COOR₁₀, in which R₁₀ is H or C₁-C₁₈ alkyl; W is C₁-C₂₄ alkylene, C₅-C₇-cycloalkylene, —O—(CH₂—O)ₚ—, —O—(CH₂—CH₂—O)_{q}—, —O—((CH₂)_{z}—O)_{z}— or —CH₂-T-CH₂—CHZ—CH₂—; T is C₁-C₂₄ alkylene, C₅-C₇ cycloalkylene, —O—(CH₂—O)ₚ—, —O—(CH₂—CH₂—O)_{q}—, —O—(CH₂)_{z}—O—; in which p, q, z and t independently of one another are integers from 0 to 100; Y is a group

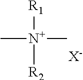

in which R₁ and R₂ independently of one another are H, C₁-C₁₈ alkyl or C₁-C₁₈ alkylene, the alkylene group being joined to a nitrogen atom of another group Y, or R₁ and R₂, together with the nitrogen atom to which they are joined, denote a five-, six- or seven-membered ring or Y is a group

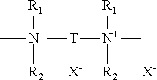

in which R₁ and R₂ independently of one another are H, C₁-C₁₈-alkyl or C₁-C₁₈ alkylene, the alkylene group being joined to a nitrogen atom of another group Y, or the two radicals R₁, together with T and with the nitrogen atoms to which they are joined, denote a five-, six- or seven-membered ring; and X⁻ are halides, anions of a C₁-C₁₈ carboxylic acid, anions of an aromatic or aliphatic sulfonic acid, sulfate, anions of an aromatic or aliphatic phosphoric acid, borate, nitrate, ClO₄⁻, PF₆⁻, or BF₄⁻.

In some embodiments of the present invention the polymers are selected from the group consisting of compounds according to the formula (I), polydiallyldialkylamines and copolymers thereof, polyvinylimidazoles and copolymers thereof, and mixtures thereof.

In some embodiments of the present invention the polymers are selected from compounds according to the formula (I) and/or polydiallyldialkylamines and copolymers thereof.

In embodiments of formula (I), n can be an integer between 5 and 100; Z can be H, OH or —O—C(O)Rₙ; W can be C₁-C₂₄ alkylene, —O—(CH₂—O)ₚ—, —O—(CH₂—CH₂—O)_{q}— or —(CH₂—O)ₚ—, —O—(CH₂—CH₂—O)_{q}— or —O—(CH₂)_{z}—O—; in which p, q and z independently of one another are integers from 1 to 20; and Y is as already defined.

In various embodiments of the method the coating compositions are physically curable.

In an embodiment of the method the cationic polymers are present in a fraction of 0.2% to 10% by weight, based on the total weight of the composition.

In another embodiment of the method the cationic polymers are present in a fraction of 0.4% to 2.5% by weight, based on the total weight of the composition.

In various embodiments of the method the composition further comprises incorporating binders selected from the group consisting of alkyd resins, epoxy resins, polyurethanes, vinyl acetate/ethylene copolymers, waterglasses, and also binders based on acrylates, styrene and/or vinyl esters, and mixtures thereof.

Various embodiments of the method may further comprise incorporating calcium carbonates, silicon compounds, aluminum oxide or aluminum oxide hydrate, kaolins, chalk, talc, kieselguhr and/or wood flour as fillers.

Various embodiments of the method may further comprise incorporating pigments into the coating composition.

Various embodiments of the method may further comprise incorporating water into the coating composition.

Various embodiments of the method may further comprise incorporating at least one additive selected from preservatives, thickeners, dispersants and defoamers.

Various embodiments of the method may further comprise applying the coating composition to a substrate as a wall paint, radiator coating, floor coating, window coating, door coating or stain.

Various embodiments of the method may further comprise applying the composition to substrates of metal, concrete, plaster, mortar, building plaster, wood or wood fibers, plastics, paper or plasterboard.

Embodiment of the present invention also relate to a method wherein the substrates are walls or ceilings, heaters, floors, window frames, doors and door frames or wall coverings.

Embodiments of the present invention also relate to a composition for providing antistatic properties to a substrate coating composition comprising one or more of a binder, a filler, an additive, or water; and an antistatic component comprising one or more cationic polymers comprising quaternary nitrogen atoms, wherein the one or more cationic polymers are selected from the group consisting of a) compounds according to the formula (I), b) polydiallyldialkylamines and copolymers thereof, c) polyalkyleneimines, d) polyvinylimidazoles and copolymers thereof, and e) mixtures thereof, where in formula (I) n is an integer between 5 and 500; Z is H, C₁-C₁₈ alkyl, OH, C₁-C₁₈ alkoxy, a group C(O)R₁₀, —O—C(O)R₁₀ or COOR₁₀, in which R₁₀ is H or C₁-C₁₈ alkyl; W is C₁-C₂₄ alkylene, C₅-C₇-cycloalkylene, —O—(CH₂—O)p-, —O—(CH₂—CH₂—O)_{q}—, —O—((CH₂)_{z}—O)ₜ— or —CH₂-T-CH₂—CH_{z}—CH₂—; T is C₁-C₂₄ alkylene, C₅-C₇ cycloalkylene, —O—(CH₂—O)p-, —O—(CH₂—CH₂—O)_{q}—, —O—(CH₂)z-O—; in which p, q, z and t independently of one another are integers from 0 to 100; Y is a group in which R₁ and R₂ independently of one another are H, C₁-C₁₈ alkyl or C₁-C₁₈ alkylene, the alkylene group being joined to a nitrogen atom of another group Y, or R₁ and R₂, together with the nitrogen atom to which they are joined, denote a five-, six- or seven-membered ring or Y is a group in which R₁ and R₂ independently of one another are H, C₁-C₁₈-alkyl or C₁-C₁₈ alkylene, the alkylene group being joined to a nitrogen atom of another group Y, or the two radicals R₁, together with T and with the nitrogen atoms to which they are joined, denote a five-, six- or seven-membered ring; and X— are halides, anions of a C₁-C₁₈ carboxylic acid, anions of an aromatic or aliphatic sulfonic acid, sulfate, anions of an aromatic or aliphatic phosphoric acid, borate, nitrate, ClO₄⁻, PF₆⁻, or BF₄⁻.

Various embodiments of the composition may comprise binders selected from the group consisting of alkyd resins, epoxy resins, polyurethanes, vinyl acetate/ethylene copolymers, waterglasses, binders based on acrylates, styrene and/or vinyl esters, and mixtures thereof.

Various embodiments of the composition may comprise fillers selected from the group consisting of calcium carbonates, silicon compounds, aluminum oxide or aluminum oxide hydrate, kaolins, chalk, talc, kieselguhr and wood flour.

Various embodiments of the composition may comprise water, and at least one additive selected from the group consisting of preservatives, thickeners, dispersants and defoamers.

In some embodiments of the composition, the viscosity of the composition may have a value of between 1500 and 5000 mPa·s at 20° C.

### DETAILED DESCRIPTION OF THE INVENTION

### Coating Compositions

Principles and embodiments of the present invention relate to compositions in which the aforementioned cationic polymers are curable thermally, with actinic radiation or physically. In some embodiments, they are physically curable. In one or more embodiments, they are curable neither thermally nor with actinic radiation.

In an embodiment, the compositions may be typically cured physically at the prevailing room temperature (generally below 40° C., preferably 18 to 28° C., in another embodiment the composition may be cured at 20 to 25° C.). Curing can be accomplished more particularly by evaporation of the volatile constituents such as water or organic solvents, or with coalescence of binder particles.

The term “thermal curing” denotes the heat-initiated crosslinking of the coating material. Heat is considered to be temperatures upward of 40° C., more particularly upward of 60° C.

In the context of the present invention, “actinic radiation” means electromagnetic radiation such as near infrared (NIR), visible light, UV radiation, X-radiation or γ radiation, particularly UV radiation, and particulate radiation such as electron beams, beta radiation, alpha radiation, proton beams or neutron beams, more particularly electron beams.

In one or more embodiments of the present invention, the compositions may be coating materials which are suitable both for the exterior sector and for the interior sector. In some embodiments, they are coating materials for the interior architectural sector (interior coating compositions). Examples of such coatings and paints are wall paints, radiator coatings and floor coatings, and also coatings for windows and doors. The radiator, window, door and floor coatings are referred to below generally as coatings.

In an embodiment, the wall paints and coatings may be pigmented. Their solids content may be 20% to 80% by weight, or 50% to 75% by weight, based in each case on the total weight of the composition.

In another embodiment, the composition may further be applied in the form of transparent or semi-transparent coatings, these coatings containing very small amounts of, or no, pigments and fillers. Embodiments of the coatings may contain neither pigments nor fillers. The compositions are referred to below as stains. They typically have a very low opacity or none at all. The solids content of the stains is situated preferably within a range from 5% to 50% by weight, based on the total weight of the composition.

The solids content of the composition and of its constituents is determined in accordance with DIN ISO 3251 on an initial mass of 2.0 g over a test duration of 60 minutes at a temperature of 125° C.

Wall paints are typically applied in a wet film thickness of 50 to 1000 μm, or 100 to 500 μm. The wet film thickness of the coatings may be 20 to 500 μm, or from 50 to 300 μm. Stains generally feature wet film thicknesses of 1 to 500 μm, or 10 to 200 μm.

The compositions may have a pH of 5 to 12. The pH of the wall paints may be 7 to 12 or may be 7 to 10. Where the wall paints comprise waterglasses as binders, a pH may be within the range from 10 to 12. In coatings the pH may be 5.5 to 10.

In embodiments of the present invention, the viscosity of the compositions may have a value of between 1500 and 5000 mPa·s at 20° C. (Haake VT 550 rotational viscometer with E100 spindle (d=16 mm, 1=35 mm) rotary speed 200 min⁻¹, shear rate 20.21 s⁻¹).

The weight fractions of all of the constituents of the composition add up to 100% by weight.

### Cationic Polymers

Principles and embodiments of the present invention relate to cationic polymers which comprise quaternary nitrogen atoms that are selected from the abovementioned groups a to d and also from mixtures of these. They can also be selected from groups a, b and d and also mixtures of these, or from a and/or b. In embodiments of the present invention, the cationic polymers are the compounds according to formula (I). They may produce antistatic properties by methods of incorporating one or more cationic polymers comprising quaternary nitrogen atoms as antistat(s) to a coating composition.

In embodiments of the present invention, the quaternization may be accomplished, for example, by alkylating the nitrogen atoms. Examples of common alkylating agents include alkyl halides or dialkyl sulfates. Suitable alkyl halides are C₁ to C₄ alkyl halides, or the may be methyl or ethyl chloride. In some embodiments, suitable dialkyl sulfates have 1 to 4 carbons per alkyl group, or may be methyl and/or ethyl groups.

Principles and embodiments of the present invention relate to a method of producing coating compositions having antistatic properties by adding cationic polymers into the coating compositions.

In embodiments of the present invention, the fraction of the cationic polymers in the coating compositions may be 0.2% to 10% by weight, or may be 0.4% to 2.5% by weight, or may even be 0.8% to 2.5% by weight, based in each case on the total weight of the coating composition. Where the compositions contain less than 0.2% by weight of the cationic compounds, the dust repellancy property is too small. At excessive fractions, above 10% by weight, there are decreases in abrasion resistance, storage stability and processing properties.

In embodiments, the cationic compounds of groups a, b and d may have a weight-average molecular weight of 20,000 to 500,000 g/mol. In one or more embodiments the cationic compounds have a weight-average molecular weight of 30,000 to 400,000 g/mol, or may be from 40,000 to 300,000 g/mol. The weight-average molecular weight of the cationic compounds c may be from 1000 g/mol to 10,000 g/mol, or may be 1100 g/mol to 6000 g/mol. The average molecular weight has been determined by means of gel permeation chromatography (GPC) with a dextran standard. Eluents used were aqueous sodium nitrate solutions (0.5 M) admixed with 0.02% by weight of sodium azide, based on the total weight of the solution.

In embodiments of the present invention, halides, anions of a carboxylic acid, more particularly anions of a C₁-C₁₈ carboxylic acid, anions of an aromatic or aliphatic sulfonic acid, sulfate, hydrogen sulfate, methyl sulfate, ethyl sulfate, methyl sulfonate, anions of an aromatic or aliphatic phosphoric acid or phosphinic acid, borate, nitrate, nitride, thiocyanate, ClO₄⁻, PF₆⁻, or BF₄⁻ form the counterions of the cationic polymers. In some embodiments, the counterions are halides, anions of an aromatic or aliphatic sulfonic acid, sulfate, anions of an aromatic or aliphatic phosphoric acid, borate, nitrate, ClO₄⁻, PF₆⁻, or BF₄⁻. In some embodiments, the counterions are halides, anions of an aromatic or aliphatic sulfonic acid, sulfate and anions of an aromatic or aliphatic phosphoric acid. In some embodiments, the counterions are halides, or may be particularly chlorides.

Examples of suitable anions of an aromatic or aliphatic sulfonic acid are the derivatives of methylbenzenesulfonic acid, more particularly the tosylate, or alkylsulfonates such as methyl- or ethylsulfonates and also trifluoromethyl- or trifluoroethylsulfonates. Examples of suitable anions of an aromatic or aliphatic phosphoric acid are phosphate or dialkylphosphates such as dimethyl- or diethylphosphates.

In embodiments of the present invention, the cationic compounds are preferably miscible with water. The cationic polymers may be advantageously provided in an aqueous solution. The fraction of cationic polymers in these aqueous solutions may be 10% to 80% by weight, or 30% to 70% by weight, or may be 30% to 60% by weight. The pH of these solutions can be 4 to 12, or from 4.5 to 11.5, or even from 4.5 to 8.

Polymers a): Compounds according to formula (I) Suitable cationic polymers are compounds according to the formula (I)

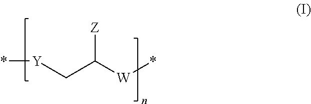

in which
n is an integer between 5 and 500;
Z is H, C₁-C₁₈ alkyl, OH, C₁-C₁₈ alkoxy, a group C(O)R₁₀, —O—C(O)R₁₀ or COOR₁₀, in which R₁₀ is H or C₁-C₁₈ alkyl; W is C₁-C₂₄ alkylene, C₅-C₇-cycloalkylene, —O—(CH₂—O)ₚ—, —O—(CH₂—CH₂—O)_{q}—, —O—((CH₂)_{z}—O)_{z}— or —CH₂-T-CH₂—CHZ—CH₂—; T is C₁-C₂₄ alkylene, C₅-C₇ cycloalkylene, —O—(CH₂—O)ₚ—, —O—(CH₂—CH₂—O)_{q}—, —O—(CH₂)_{z}—O—; in which p, q, z and t independently of one another are integers from 0 to 100; Y is a group

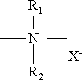

in which

R₁ and R₂ independently of one another are H, C₁-C₁₈ alkyl or C₁-C₁₈ alkylene, the alkylene group being joined to a nitrogen atom of another group Y, or R₁ and R₂, together with the nitrogen atom to which they are joined, denote a five-, six- or seven-membered ring or Y is a group

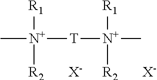

in which

R₁ and R₂ independently of one another are H, C₁-C₁₈-alkyl or C₁-C₁₈ alkylene, the alkylene group being joined to a nitrogen atom of another group Y, or the two radicals R₁, together with T and with the nitrogen atoms to which they are joined, denote a five-, six- or seven-membered ring; and

X⁻ is selected from the counterions already stated.

Suitable compounds and also processes for preparing compounds according to formula (I) are described in European specification EP-A-2186845.

The alkylene group which joins two nitrogen atoms of two groups Y to one another is shown in an exemplarily manner by the following formula:

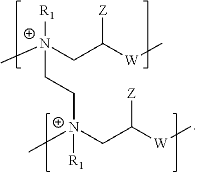

In embodiments of the compounds according to formula (I)

n is an integer between 5 and 100;

Z is H, OH or —O—C(O)R₁₀;

W is C₁-C₂₄ alkylene, —O—(CH₂—O)ₚ—, —O—(CH₂—CH₂—O)_{q}— or —CH₂-T-CH₂—CHZ—CH₂—;

T is C₁-C₂₄ alkylene, —O—(CH₂—O)ₚ—, —O—(CH₂—CH₂—O)_{q}— or —O—(CH₂)_{z}—O—;

in which p, q and z independently of one another are integers from 1 to 20;

and Y is the groups identified above.

In some embodiments, n is an integer between 10 to 100, or from 20 to 80.

In an embodiment, Z is an OH group.

In an embodiment, W is a C₂-C₂₄ alkylene group or —CH₂-T-CH₂—CHZ—CH₂— where T=—O—(CH₂—CH₂—O)_{q}— or —O—(CH₂)_{z}—O—.

In an embodiment, a group Y is

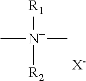

in which R₁ and R₂ independently of one another are C₂-C₁₈ alkyl or C₁-C₁₈ alkylene, the alkylene group being joined to a nitrogen atom of another group Y,

or a group Y is

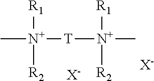

in which the two radicals R₁, together with T and the nitrogen atoms to which they are joined, form a five-, six- or seven-membered ring and the two radicals R₂ independently of one another are C₁-C₁₈ alkyl. With very particular preference a six-membered ring is formed, more particularly piperazine.

Embodiments of the present invention can relate to compound I according to the formula (I) in which

Z is an OH group, W is a C₁-C₆ alkylene group, which may be particularly a methylene group,

Y is the group

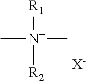

in which R₁ and R₂ are C₁-C₆ alkyl or C₁-C₆ alkylene, and more particularly R₁ is a methyl group and R₂ is a methyl group or an ethylene group, the alkylene groups being joined to a nitrogen atom of another group Y. Suitable compounds according to the formula (I) are available, for example, under the name Catiofast 159 (BASF SE, Ludwigshafen) or Magnafloc LT31 (BASF SE, Ludwigshafen).

Embodiments of the present invention can also relate to compound II according to the formula (I) in which Z is an OH group, W is a group —CH₂-T-CH₂—CHZ—CH₂— with Z═OH and T=—O—(CH₂—CH₂—O)_{q}— with q=5 to 14, preferably with q=9, or —O—(CH₂)_{z}—O— with z=3 to 5, preferably with z=4, and Y is the group

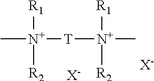

in which the two radicals R₁, together with T and the nitrogen atoms to which they are joined, form a six-membered ring, which may be particularly piperazine, and the two radicals R₂ independently of one another are C₁-C₆ alkyl, which may be methyl or ethyl. Compounds of this kind are indicated for instance in the examples of document EP-A-2186845.

Compounds according to the formula (I) preferably have a weight-average molecular weight of 30,000 g/mol to 150,000 g/mol or of 40,000 g/mol to 120,000 g/mol.

Embodiments of the compounds according to formula (I) may have an equivalence weight of permanent amine cations of 0.014 to 0.73 meq per gram of composition. In another embodiment, the equivalence weight is 0.028 to 0.18 meq/g, or may be 0.058 to 0.18 meq/g.

In one or more embodiments, polymers a) in the cationic form have the following general structure:

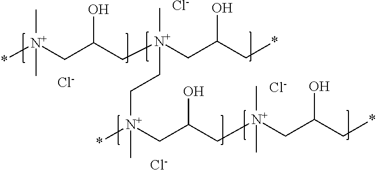

Polymers b): Polydiallyldialkylamines and copolymers thereof.

In some embodiments, the alkyl groups of the polydiallyldialkylamines contain preferably 1 to 4 C atoms each, or may contain 1 C atom each. The quaternary nitrogen atom may be part of a heterocycle, or may be pyrrolidine. An embodiment of the polydiallyldialkylamines comprises, in the cationic form, 1,1-dialkyl-3,4-divinylpyrrolidin-1-ium. The alkyl groups may be C₁ to C₆ alkyl, or particularly methyl or ethyl.

The diallyldialylamine monomers may be part of a copolymer. In various embodiments, suitable comonomers are uncharged vinyl monomers. The vinyl monomers may be water-soluble. Suitable examples include acrylamides or vinylpyrrolidone.

The weight-average molecular weight may be 50,000 g/mol to 250,000 g/mol, or may be 80,000 g/mol to 220,000 g/mol.

Embodiments of the present invention relate to polydiallyldialkylamines and copolymers thereof that may have an equivalence weight of permanent amine cations of 0.12 to 6 meq per gram of composition. The equivalence weight can be 0.24 to 1.5 meq/g, or may be 0.48 to 1.5 meq/g.

In various embodiments, polymers b) in the cationic form have the following general structure:

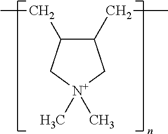

Polydiallyldimethylammonium chlorides are available, for example, under the name Magnafloc® LT35 (BASF SE, Ludwigshafen).

Polymers c): Polyalkyleneimines

Polyalkyleneimines are branched polymers which contain secondary and tertiary amino groups and whose hydrocarbon chains which join the nitrogen atoms to one another have 1 to 18, or 2 to 8, saturated C atoms and/or are unsaturated, straight-chain and/or branched hydrocarbon chains. In some embodiments, polyalkyleneimines are polyethyleneimines.

The polyalkyleneimines adsorb on the surface of a substrate, as a result of which the nitrogen atoms are quaternized. Accordingly, the polyalkyleneimines which are used initially are quaternizable polymers. They constitute cationic polymers in the sense of the invention.

The polyalkyleneimines preferably have an equivalence weight of quaternizable amines of 0.046 to 2.32 meq per gram of composition. The equivalence weight is more preferably 0.092 to 0.58 meq/g, very preferably 0.18 to 0.58 meq/g.

In various embodiments, polymers c) have the following general structure:

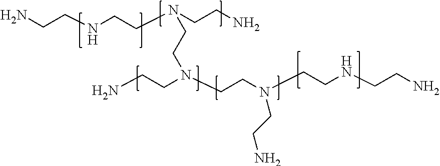

Suitable polyethyleneimines are available commercially, for example, under the name Lupasol® G20 or Lupasol® G100 (BASF SE, Ludwigshafen).

Polymers d): Polyvinylimidazoles and Copolymers Thereof

In various embodiments, suitable compounds are cationic polymers of the polyvinylimidazoles. In some embodiments, preference is given to using copolymers, which may be block copolymers, of vinylpyrrolidone and vinylimidazole. They may have a weight-average molecular weight of 20,000 g/mol to 60,000 g/mol, or from of 30,000 g/mol to 50,000 g/mol.

Embodiments of the present invention relate to polyvinylimidazoles and copolymers thereof that may have an equivalence weight of permanent amine cations of 0.014 to 0.7 meq per gram of composition. The equivalence weight can also be 0.028 to 0.18 meq/g, or 0.056 to 0.18 meq/g.

In various embodiments, polymers d) in the cationic form have the following general structure:

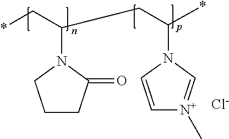

Copolymers of vinylpyrrolidone and quaternized vinylimidazole chlorides are available under the name Luviquat® Excellence (BASF SE, Ludwigshafen).

Binders

Binders in the sense of the present invention are organic, polymeric compounds which in the composition are responsible for film-forming and which are assembled below. They represent the nonvolatile fraction of the coating material, without pigments, cationic polymers and fillers (in analogy to DIN EN 971-1: 1996-09).

In one or more embodiments, the compositions comprise at least one binder. The binder fraction may be 1% to 90% by weight, based on the total weight of the composition. More preference is given to a binder fraction of 5% to 80% by weight, and very preferably of 6% to 70% by weight. In wall paints and coatings, the binder fraction may be 1% to 80% by weight, or from 3% to 50% by weight. Stains contain 10% to 90% by weight of binder(s).

Binders which may be present in the composition include alkyd resins, epoxy resins, polyurethanes, vinyl acetate/ethylene copolymers, waterglasses, more particularly potassium waterglasses, and also binders based on acrylates, styrene and/or vinyl esters such as styrene acrylates or butyl acrylates. Compositions which comprise waterglasses comprise them in a fraction of 1% to 98% by weight, or from 5% to 40% by weight, based in each case on the total weight of the composition.

The minimum film-forming temperature of the binders may be 0° C. to 40° C., or 0° C. to 20° C. For interior sector coatings, the binders can have a minimum film-forming temperature of 0° C. to 5° C. The minimum film-forming temperature indicates the temperature above which a coherent film is formed. Below this temperature, film formation is generally disrupted or incomplete. The determining is made in accordance with DIN 53787: 1974-02 (cf. Römpp Lacke and Druckfarben, Georg Thieme Verlag Stuttgart/New York 1998, ISBN 3-13-776001-1, entry heading “Mindestfilmbildetemperatur”).

In wall paints it is preferred to use vinyl acetate/ethylene copolymers, styrene acrylates, butyl acrylates or mixtures of these polymers. Coatings can comprise polyurethanes, acrylates, alkyd resins or epoxy resins and also mixtures of these. The stains may comprise the binders specified for wall paints and coatings.

Fillers

In one or more embodiments, the composition may comprise calcium carbonates, silicon compounds such as silicon dioxide or aluminum silicates or magnesium aluminum silicates, aluminum oxide or aluminum oxide hydrate, kaolins, chalk, talc, kieselguhr or wood flour as fillers. The fraction of fillers may be 0% to 90% by weight, based on the total weight of the composition.

Stains may contain not more than 5% by weight, or not more than 2% by weight and may also be not more than 1% by weight of fillers. In some embodiments, the stains contain no fillers.

Where the composition is a wall paint, the filler fraction may be 1% to 90% by weight, or 20% to 60% by weight.

In coatings, the fraction of fillers may be in the range from 0% to 60% by weight, or 0% to 35% by weight.

Pigments

In one or more embodiments, the composition may further comprise pigments. Their fraction in the composition may be 0% to 75% by weight, based on the total weight of the composition. In wall paints the pigment fraction may be in the range from 0% to 50% by weight, or in the range from 4% to 25% by weight. In coatings a pigment fraction of 10% to 60% by weight is preferred. The pigment fraction in stains is preferably 0% to 15% by weight. Stains may contain only transparent pigments or no pigments at all, and in some embodiments no pigments at all.

Pigments are colorants in powder or flake form which unlike dyes are insoluble in surrounding medium (cf. Römpp Lacke and Druckfarben, Georg Thieme Verlag Stuttgart/New York 1998, ISBN 3-13-776001-1, entry heading “Pigmente”).

The pigment can be selected from the group consisting of organic and inorganic, coloring, effect-imparting, color- and effect-imparting, transparent, magnetically shielding, electrically conductive, corrosion-inhibiting, fluorescent and phosphorescent pigments. Preferred pigments are color- and effect-imparting pigments for wall paints and coatings, and transparent pigments for stains.

Water

In one or more embodiments, the compositions may comprise water, which may be 8% to 60% by weight, or 15% to 50% by weight, of water is present.

Organic Solvents

In one or more embodiments, the compositions may further comprise organic solvents. The fraction of organic solvents in the wall paints may be less than 5% by weight, or less than 2% by weight, or may be less than 1% by weight, based in each case on the total weight of the wall paints. In an embodiment, the wall paints contain no organic solvents.

Examples of organic solvents included in wall paints are trimethylpentane, propylene glycol or dipropylene glycol butyl ether.

The fraction of organic solvents in coatings may be 0% to 30% by weight or 0% to 10% by weight, based in each case on the total weight of the coatings. Examples of suitable organic solvents include white spirit, esters such as butyl acetate or butyldiglycol acetate or ethers such as glycol ethers or methyl ethyl ketone.

Stains contain solvents in a fraction of 0% to 60% by weight, or of 0% to 40% by weight, based in each case on the total weight of the stains. Suitability is possessed by the solvents specified for wall paints and coatings.

Additives

In one or more embodiments, the composition may comprise additives such as preservatives, thickeners, dispersants and defoamers.

Examples of suitable preservatives are isothiazolinone preparations such as 2-methyl-2H-isothiazol-3-one or 1,2-benzisothiazolin-3H-one. One suitable aqueous preparation is available, for example, under the name Acticide MBS from Thor GmbH, Speyer. The fraction of preservative is preferably 0% to 2% by weight, or 0.001% to 0.3% by weight, based in each case on the total weight of the composition.

Suitable thickeners are the thickeners familiar to the skilled person for coatings and paints. Examples include cellulose ethers, bentonite, polysaccharides, fumed silicas or phyllosilicates. The preferred fraction is 0% to 3% by weight, or 0.001% to 1% by weight, based in each case on the total weight of the composition.

Dispersants contemplated include the dispersants known to the skilled person for coatings and paints. Examples include alkylbenzenesulfonates, polycarboxylates, fatty acid amines or salts of polyacrylic acids. The fraction is preferably 0% to 2% by weight, or 0.001% to 0.5% by weight, based in each case on the total weight of the composition.

Examples of suitable defoamers are poly(organo)siloxanes, silicone oils or mineral oils. The defoamer fraction is preferably 0% to 1% by weight, more preferably 0% to 0.5% by weight, based in each case on the total weight of the composition.

The additives recited are not considered to be binders in the sense of this invention.

### Further Embodiments of the Invention

Principles and embodiments of the present invention also relate to methods of producing antistatic coatings and incorporating antistats in coating materials for the interior architectural sector (interior coating compositions). The compounds and compositions may be coating materials which can be employed by the exterior architectural sector, as wall paints, such as interior wall paints, coatings, for example for windows, doors, radiators or floors, or stains, in each case preferably for the interior sector.

The stains have the particular advantage that they can be applied subsequently to substrates that have already been painted or varnished, in order to provide a dust-repellant coating as a supplement.

In various embodiments, the compositions in which the antistats are incorporated are suitable for coating substrates which are fitted or installed, or are to be fitted or installed, in the interior or exterior architectural sector, for example the interior sector. The substrates are composed typically of metal, concrete, plaster, mortar, building plaster, wood or wood fibers, plastics, paper, plasterboard. Suitable substrates are used or employed, for example, as walls or ceilings, heaters, floors, window frames, doors and door frames or wall coverings. The walls or ceilings may be composed for example of concrete, wood or plasterboard, may have been plastered or may carry coverings. The compositions can be applied to substrates which have already been fitted or installed in or on the building. It is likewise possible first to coat the substrates such as wall coverings, plasterboard panels, doors or windows, for example, and subsequently to fit them or install them in or on the building.

In various embodiments, the compositions are applied by all customary and known application methods suitable for the coating materials in question, such as spraying, squirting, knife coating, spreading, pouring, dipping, trickling or rolling, for example, and are subsequently dried. Preference is given to squirting, spraying or spreading. Curing takes place typically at room temperature, more particularly physically.

The invention is elucidated further below with reference to various non-limiting examples.

### EXAMPLES

1. Antistatic Properties

Interior coating compositions of examples 1 to 9 were prepared, using Magnafloc® LT35 as cationic polymer (aqueous solution, containing 40% by weight of cationic polymer).

Formula examples of interior wall paints with and without antistat

| | Figures in parts by weight | | | | |
|---|---|---|---|---|---|
| | Example | Example | Example | Example | Example |
| Component | 1 | 2 | 3 | 4 | 5 |
| Water | 34 | 34 | 34 | 34 | 34 |
| Dispersant | 0.3 | 0.3 | 0.3 | 0.3 | 0.3 |
| (polycarboxylate) | | | | | |
| Celluloseether | 0.3 | 0.3 | 0.3 | 0.3 | 0.3 |
| thickener | | | | | |
| Polyurethane | 0.4 | 0.4 | 0.4 | 0.4 | 0.4 |
| thickener | | | | | |
| Preservative | 0.2 | 0.2 | 0.2 | 0.2 | 0.2 |
| isothiazolinone | | | | | |
| preparation | | | | | |
| Defoamer (siloxane | 0.2 | 0.2 | 0.2 | 0.2 | 0.2 |
| oligomer) | | | | | |
| Polymer dispersion | 16 | 16 | 16 | 16 | 16 |
| (vinyl acetate/ethylene) | | | | | |
| Pigment (titanium | 15 | 15 | 15 | 15 | 15 |
| dioxide, rutile) | | | | | |
| Filler CaCO3 | 8 | 8 | 8 | 8 | 8 |
| precipitated | | | | | |
| Filler aluminum | 15 | 15 | 15 | 15 | 15 |
| silicate | | | | | |
| Filler talc | 4 | 4 | 4 | 4 | 4 |
| Filler calcite | 6.6 | 6.6 | 6.6 | 6.6 | 6.6 |
| (CaCO3) | | | | | |
| Magnafloc ® LT35 | 0 | 1 | 3 | 4 | 5 |
| Total | 100 | 101 | 103 | 104 | 105 |

Properties

| | | | | | |
|---|---|---|---|---|---|
| Dust attraction -dL | 7 | 5.5 | 1.3 | n.d. | 1.1 |
| Surface resistance in | 6.53E+09 | 3.26E+09 | 1.10E+08 | 3.76E+07 | 2.15E+07 |
| Ω/sq, | | | | | |
| rel. humidity: 50% | | | | | |
| Wet abrasion in μm | 15 | n.d. | n.d. | 21 | n.d. |
| Processing | 5 | 4 | 5 | 5 | 4 |

n.d. = not determined

The compositions admixed with Magnafloc® LT35 exhibit a significantly reduced dust attraction. Additionally, the surface resistance of the composition comprising the cationic polymer is lower than in the composition without the cationic polymer. Accordingly, the antistatic, dust repellancy property is enhanced by the addition of the cationic polymer.

Formula examples of interior wall paints with and without antistat

| | Figures in parts by weight | | | |
|---|---|---|---|---|
| | Example | Example | Example | Example |
| Component | 6 | 7 | 8 | 9 |
| Water | 31.9 | 31.9 | 31.9 | 31.9 |
| Dispersant | 0.3 | 0.3 | 0.3 | 0.3 |
| (polycarboxylate) | | | | |
| Celluloseether | 0.4 | 0.4 | 0.4 | 0.4 |
| thickener | | | | |
| Polyurethane | 0 | 0 | 0 | 0 |
| thickener | | | | |
| Preservative | 0.2 | 0.2 | 0.2 | 0.2 |
| isothiazolinone | | | | |
| preparation | | | | |
| Defoamer (siloxane | 0.2 | 0.2 | 0.2 | 0.2 |
| oligomer) | | | | |
| Polymer dispersion | 10 | 10 | 10 | 10 |
| (vinyl acetate/ethylene) | | | | |
| Pigment (titanium | 5 | 5 | 5 | 5 |
| dioxide, rutile) | | | | |
| Filler CaCO3 | 6 | 6 | 6 | 6 |
| precipitated | | | | |
| Filler aluminum silicate | 0 | 0 | 0 | 0 |
| Filler talc | 6 | 6 | 6 | 6 |
| Filler calcite | 40 | 40 | 40 | 40 |
| (CaCO3) | | | | |
| Magnafloc ® LT35 | 0 | 1 | 3 | 5 |
| Total | 100 | 101 | 103 | 105 |

Properties

| | | | | |
|---|---|---|---|---|
| Dust attraction -dL | 9.5 | 7.4 | 7.8 | 7.8 |
| Surface resistance in | 1.66E+10 | 1.27E+09 | 3.47E+07 | 7.52E+06 |
| Ω/sq, | | | | |
| rel. humidity: 50% | | | | |
| Wet abrasion in μm | 72 | 54 | 82 | 98 |
| Processing | 5 | 3 | 5 | 4 |

In the same way as for examples 2 to 5, presented above, examples 7 to 9, with a different coating composition, also have an enhanced antistatic, dust repellancy property.

Examples 2 to 5 were repeated, with different cationic polymers being investigated.

| | | | Surface | Surface |
|---|---|---|---|---|
| | | | resistance | resistance |
| | | | in Ω/sq | in Ω/sq |
| | Parts by weight | | rel. | rel. |
| | in paint from | | humidity: | humidity: |
| | example 1 | -dL | 50% | 30% |
| Catiofast ® 159 | 3 | 0.9 | n.d. | n.d. |
| Catiofast ® 159 | 5 | 1.3 | 2.38E+07 | 1.65E+08 |
| Magnafloc ® LT31 | 3 | 1.4 | n.d. | n.d. |
| Magnafloc ® LT31 | 5 | 1.0 | 2.43E+07 | 3.10E+08 |
| Luviquat ® | 1 | 3.5 | n.d. | n.d. |
| Excellence | | | | |
| Luviquat ® | 3 | 2.8 | n.d. | n.d. |
| Excellence | | | | |
| Luviquat ® | 5 | 2.1 | 2.63E+07 | 2.08E+08 |
| Excellence | | | | |
| Lupasol ® G20 | 1 | 5.9 | n.d. | n.d. |
| Lupasol ® G20 | 5 | 3.2 | 4.19E+09 | 3.48E+11 |
| Lupasol ® G100 | 3 | 4.8 | n.d. | n.d. |
| Lupasol ® G100 | 5 | 2.4 | 5.93E+09 | 3.89E+11 |
| Example 1 as | 0 | 7 | 6.53E+09 | 1.32E+11 |
| comparative | | | | |

Dust Test

The dust test is carried out along the lines of the test from WO 01/12713 A.

In order to investigate dust accumulation in a laboratory experiment, the specimens are first of all coated. The coated panels are then exposed to an atmosphere with swirled dust. For this purpose, a 2 liter beaker with a magnetic stirring rod having a triangular cross section and a length of 80 mm is filled with dust (coal dust/20 g activated carbon, Riedel-de Haen, Seelze, Germany, Article No. 18003) to a height of approximately 1 cm. With the aid of a magnetic stirrer, the dust is swirled and the specimen is exposed to this dust atmosphere, with the stirrer running, for 14 seconds. Depending on the specimen used, a greater or lesser quantity of dust settles on the specimens. The dust is fixed by sprayed application of a clear matt varnish. The dust accumulations (dust figures) are evaluated by means of a spectrophotometric analysis carried out. For the spectrophotometric analysis a horizontal spectrophotometer (CM-3600 from Minolta) is used.

The −dL value determined is given by the following formula:

−dL=L*(specimen after exposure in the dust atmosphere and fixing with matt varnish)−L*(specimen without dust treatment with matt varnish treatment)

The value L* indicates the lightness, between 0 and 100; a value of 100 corresponds to the maximum lightness. The lightness L* is defined according to the colorimetric standard (CIE1964: L*C*h). This standard is determined in accordance with DIN 6167 at an angle of 10° under standard illuminant D65 (in accordance with ISO 3664: radiation distribution with a color temperature of 6504 K). The slight yellowing or reduction of L* through application of the matt varnish can be disregarded.

Determination of the Surface Resistance

The paint dispersions were applied with a knife coater in a wet film thickness of 300 μm to polymeric films (Leneta chart, Leneta, Mahwah, N.H., 07430 USA). Drying took place at 20° C. and a relative humidity of 50% for at least 24 hours.

The surface conductivity values SR [ohm/square] were measured using a spring electrode in analogy to the standard DIN 53482 at a voltage of 500 V and 22° C. and with a controlled relative humidity (RH). Prior to the measurement, the samples were subjected to preliminary storage for at least 5 days at the humidity selected for the measurement.

Wet Abrasion

The wet abrasion was determined in accordance with DIN EN 13300. For this purpose, the coating material was drawn down using a knife coater in a wet film thickness of 300 μm onto a PVC film (Leneta chart, Leneta, Mahwah, N.H., 07430 USA) and dried in a conditioned room at 20° C. and 50% relative humidity for 28 days. The samples are subsequently cut to size and the gross weight is determined using an analytical balance. For the determination of the wet abrasion, the samples are exposed in a specific scuffing instrument from Erichsen, using a scuffing pad S-UFN 158×224 mm from 3M Scotch-Brite™, to a total of 200 scuffing movements with accompanying exposure to a 0.25% strength aqueous surfactant solution (Marlon® A 350 surfactant from Sasol Germany GmbH). The samples are subsequently washed off and dried to constant weight in a drying oven at 50° C., and the net weight is determined. From the weight loss, the weight abrasion value in μm, relative to the dry film thickness, is subsequently determined.

Processing

Processing indicates the visual assessment of processing on a scale from 0=poor to 5=very good. In this assessment, qualities such as the processing properties, the flow and the splash tendency are assessed.

2. Influence of the Cationic Polymers on the Color Properties

This influence was determined on the basis of a paint formulation according to formula example 1. For this purpose the values with and without cationic polymer were ascertained.

| | Parts by | | |
|---|---|---|---|
| | weight in | | |
| | paint from | | Yellowness |
| | example 1 | L* | index |
| Without cationic | 0 | 96.3 | 2.75 |
| polymer | | | |
| Catiofast ® 159 | 3 | 96 | 3.43 |
| Catiofast ® 159 | 5 | 96 | 3.43 |
| Magnafloc ® LT31 | 3 | 96 | 3.43 |
| Magnafloc ® LT31 | 5 | 96 | 3.43 |
| Magnafloc ® LT35 | 1 | 96.2 | 3.13 |
| Magnafloc ® LT35 | 3 | 96 | 3.13 |
| Magnafloc ® LT35 | 5 | 96 | 3.13 |
| Luviquat ® | 1 | 96.2 | 3.13 |
| Excellence | | | |
| Luviquat ® | 3 | 96 | 3.13 |
| Excellence | | | |
| Luviquat ® | 5 | 96 | 3.06 |
| Excellence | | | |
| Lupasol ® G20 | 1 | 96.2 | 3.72 |
| Lupasol ® G20 | 3 | 96 | 3.92 |
| Lupasol ® G20 | 5 | 95.9 | 3.55 |
| Lupasol ® G100 | 1 | 96.1 | 3.91 |
| Lupasol ® G100 | 3 | 96 | 3.81 |
| Lupasol ® G100 | 5 | 95.9 | 3.55 |

L* is defined in accordance with the colorimetric standard (CIE1964: L*C*h) (see above). The yellowness index is calculated arithmetically from the colorimetric data in accordance with DIN 6167.

The investigations show that the added cationic polymers do not significantly influence the color properties.

3. Shelf Life

The surface resistance was determined on the basis of example 1 and of example 1 plus 4 parts of solution of a cationic polymer after 14 days at 20° C. and 50° C. and with different relative humidities.

| | Surface | Surface |
|---|---|---|
| | resistance in | resistance in |
| | Ω/sq | Ω/sq |
| | rel. humidity: | rel. humidity: |
| Composition | 50% | 30% |
| Example 1 after 14 days at | 2.94E+09 | 2.08E+11 |
| 20° C./homogenization | | |
| Example 1 after 14 days at | 2.90E+09 | 3.23E+11 |
| 50° C./homogenization | | |
| Example 1 plus 4 parts | 3.73E+07 | 2.10E+09 |
| Catiofast ® 159 | | |
| after 14 days at | | |
| 20° C./homogenization | | |
| Example 1 plus 4 parts | 2.83E+07 | 1.52E+09 |
| Catiofast ® 159 | | |
| after 14 days at | | |
| 50° C./homogenization | | |
| Example 1 plus 4 parts | 3.16E+07 | 1.45E+09 |
| Magnafloc ® LT 31 | | |
| after 14 days at | | |
| 20° C./homogenization | | |
| Example 1 plus 4 parts | 3.08E+07 | 1.58E+09 |
| Magnafloc ® LT 31 | | |
| after 14 days at | | |
| 50° C./homogenization | | |
| Example 1 plus 4 parts | 3.76E+07 | 7.83E+08 |
| Magnafloc ® LT 35 | | |
| after 14 days at | | |
| 20° C./homogenization | | |
| Example 1 plus 4 parts | 3.69E+07 | 9.25E+08 |
| Magnafloc ® LT 35 | | |
| after 14 days at | | |
| 50° C./homogenization | | |
| Example 1 plus 4 parts | 4.00E+07 | 6.22E+08 |
| Luviquat ® Excellence | | |
| after 14 days at | | |
| 20° C./homogenization | | |
| Example 1 plus 4 parts | 3.96E+07 | 5.78E+08 |
| Luviquat ® Excellence | | |
| after 14 days at | | |
| 50° C./homogenization | | |

What is claimed is:

1. A method of providing antistatic properties to coating compositions comprising:
incorporating one or more cationic polymers comprising quaternary nitrogen atoms as an antistat to a coating composition, wherein the one or more cationic polymers are selected from the group consisting of
a) compounds according to the formula (I) 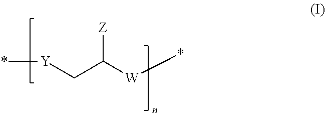
b) polydiallyldialkylamines and copolymers thereof,
c) polyalkyleneimines,
d) polyvinylimidazoles and copolymers thereof, and
e) mixtures thereof,
where in formula (I)
n is an integer between 5 and 500;
Z is H, C₁-C₁₈ alkyl, OH, C₁-C₁₈ alkoxy, a group C(O)R₁₀, —O—C(O)R₁₀ or COOR₁₀, in which R₁₀ is H or C₁-C₁₈ alkyl;
W is C₁-C₂₄ alkylene, C₅-C₇-cycloalkylene, —O—(CH₂—O)ₚ—, —O—(CH₂—CH₂—O)_{q}—, ((CH₂)_{z}—O)ₜ— or —CH₂-T-CH₂—CHZ—CH₂—;
T is C₁-C₂₄ alkylene, C₅-C₇ cycloalkylene, —O—(CH₂—O)ₚ—, —O—(CH₂—CH₂—O)_{q}—, —O—(CH₂)_{z}—O—;
in which p, q, z and t independently of one another are integers from 0 to 100;
Y is a group 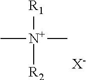
in which
R₁ and R₂ independently of one another are H, C₁-C₁₈ alkyl or C₁-C₁₈ alkylene, the alkylene group being joined to a nitrogen atom of another group Y, or R₁ and R₂, together with the nitrogen atom to which they are joined, denote a five-, six- or seven-membered ring
or Y is a group 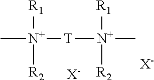
in which
R₁ and R₂ independently of one another are H, C₁-C₁₈-alkyl or C₁-C₁₈ alkylene, the alkylene group being joined to a nitrogen atom of another group Y, or the two radicals R₁, together with T and with the nitrogen atoms to which they are joined, denote a five-, six- or seven-membered ring;
and X⁻ are halides, anions of a C₁-C₁₈ carboxylic acid, anions of an aromatic or aliphatic sulfonic acid, sulfate, anions of an aromatic or aliphatic phosphoric acid, borate, nitrate, ClO₄⁻, PF₆⁻, or BF₄⁻.

2. The method of claim 1, wherein the polymers are selected from the group consisting of
a) compounds according to the formula (I),
b) polydiallyldialkylamines and copolymers thereof,
d) polyvinylimidazoles and copolymers thereof, and
e) mixtures thereof.

3. The method of claim 1, wherein the polymers are selected from
a) compounds according to the formula (I) and/or
b) polydiallyldialkylamines and copolymers thereof.

4. The method of claim 1, wherein for formula (I)
n is an integer between 5 and 100;
Z is H, OH or —O—C(O)R₁₀;
W is C₁-C₂₄ alkylene, —O—(CH₂—O)ₚ—, —O—(CH₂—CH₂—O)_{q}— or —CH₂-T-CH₂—CHZ—CH₂—;
T is C₁-C₂₄ alkylene, —O—(CH₂—O)ₚ—, —O—(CH₂—CH₂—O)_{q}— or —O—(CH₂)_{z}—O—;
in which p, q and z independently of one another are integers from 1 to 20;
and Y is as already defined.

5. The method of claim 1, wherein the coating compositions are physically curable.

6. The method of claim 1, wherein the cationic polymers are present in a fraction of 0.2% to 10% by weight, based on the total weight of the composition.

7. The method of claim 1, wherein the cationic polymers are present in a fraction of 0.4% to 2.5% by weight, based on the total weight of the composition.

8. The method of claim 1, which further comprises incorporating binders selected from the group consisting of alkyd resins, epoxy resins, polyurethanes, vinyl acetate/ethylene copolymers, waterglasses, binders based on acrylates, styrene and/or vinyl esters, and mixtures thereof.

9. The method of claim 1, which further comprises incorporating calcium carbonates, silicon compounds, aluminum oxide or aluminum oxide hydrate, kaolins, chalk, talc, kieselguhr and/or wood flour as fillers.

10. The method of claim 1, which further comprises incorporating pigments into the coating composition.

11. The method of claim 1, which further comprises incorporating water into the coating composition.

12. The method of claim 1, which further comprises incorporating at least one additive selected from preservatives, thickeners, dispersants and defoamers.

13. The method of claim 1, which further comprises applying the coating composition to a substrate as a wall paint, radiator coating, floor coating, window coating, door coating or stain.

14. The method of claim 1, which further comprises applying the composition to substrates of metal, concrete, plaster, mortar, building plaster, wood or wood fibers, plastics, paper or plasterboard.

15. The method according to claim 14, wherein the substrates are walls or ceilings, heaters, floors, window frames, doors and door frames or wall coverings.

16. A substrate coating composition comprising:
one or more of a binder, a filler, an additive, or water; and
an antistatic component comprising one or more cationic polymers comprising quaternary nitrogen atoms, wherein the one or more cationic polymers are selected from the group consisting of
a) compounds according to the formula (I) 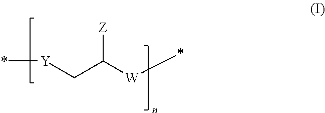
b) polydiallyldialkylamines and copolymers thereof,
c) polyalkyleneimines,
d) polyvinylimidazoles and copolymers thereof, and
e) mixtures thereof,
where in formula (I)
n is an integer between 5 and 500;
Z is H, C₁-C₁₈ alkyl, OH, C₁-C₁₈ alkoxy, a group C(O)R₁₀, —O—C(O)R₁₀ or COOR₁₀, in which R₁₀ is H or C₁-C₁₈ alkyl;
W is C₁-C₂₄ alkylene, C₅-C₇-cycloalkylene, —O—(CH₂—O)ₚ—, —O—(CH₂—CH₂—O)_{q}—, —O—((CH₂)_{z}—O)ₜ— or —CH₂-T-CH₂—CHZ—CH₂—;
T is C₁-C₂₄ alkylene, C₅-C₇ cycloalkylene, —O—(CH₂—O)ₚ—, —O—(CH₂—CH₂—O)_{q}—, —O—(CH₂)_{z}—O—;
in which p, q, z and t independently of one another are integers from 0 to 100;
Y is a group 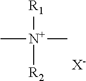
in which
R₁ and R₂ independently of one another are H, C₁-C₁₈ alkyl or C₁-C₁₈ alkylene, the alkylene group being joined to a nitrogen atom of another group Y, or R₁ and R₂, together with the nitrogen atom to which they are joined, denote a five-, six- or seven-membered ring
or Y is a group 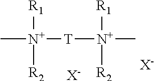
in which
R₁ and R₂ independently of one another are H, C₁-C₁₈-alkyl or C₁-C₁₈ alkylene, the alkylene group being joined to a nitrogen atom of another group Y, or the two radicals R₁, together with T and with the nitrogen atoms to which they are joined, denote a five-, six- or seven-membered ring;
and X⁻ are halides, anions of a C₁-C₁₈ carboxylic acid, anions of an aromatic or aliphatic sulfonic acid, sulfate, anions of an aromatic or aliphatic phosphoric acid, borate, nitrate, ClO₄⁻, PF₆⁻, or BF₄⁻.

17. The composition of claim 16 comprising a binder selected from the group consisting of alkyd resins, epoxy resins, polyurethanes, vinyl acetate/ethylene copolymers, waterglasses, binders based on acrylates, styrene and/or vinyl esters, and mixtures thereof.

18. The composition of claim 17 comprising a filler selected from the group consisting of calcium carbonates, silicon compounds, aluminum oxide or aluminum oxide hydrate, kaolins, chalk, talc, kieselguhr and wood flour.

19. The composition of claim 18 comprising water and at least one additive selected from the group consisting of preservatives, thickeners, dispersants and defoamers.

20. The composition of claim 19, wherein the viscosity of the composition has a value of between 1500 and 5000 mPa·s at 20° C.
